(19) United States
(12) Patent Application Publication
(10) Pub. No.: US 2009/0076972 A1
(43) Pub. Date: Mar. 19, 2009

(54) AUTOMATED LENDING SYSTEM WITH AUTOMATIC DIVERSIFICATION AND CONTRACT EXECUTION AND SPONSORSHIPS

(75) Inventors: John Witchel, San Francisco, CA (US); Christian Larsen, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Prosper Marketplace, Inc., San Francisco, CA (US)

(21) Appl. No.: 12/234,277

(22) Filed: Sep. 19, 2008

Related U.S. Application Data
(62) Division of application No. 11/270,881, filed on Nov. 8, 2005.
(60) Provisional application No. 60/625,181, filed on Nov. 8, 2004.
(60) Provisional application No. 60/625,180, filed on Nov. 8, 2004.
(60) Provisional application No. 60/625,219, filed on Nov. 8, 2004.

(51) Int. Cl. G06Q 40/00; G06Q 30/00

(52) U.S. Cl. 705/80; 705/37; 705/36 R; 705/38

(57) ABSTRACT

In the disclosed computerized lending systems, terms of contracts are coordinated between a plurality of parties, each of which operate party client systems to interface to the electronic transaction processing system, including a database of transactions representing contracts, parties to the contracts and at least essential terms of the contracts. Signaling to each of the parties can be done without identifying each party to the other, including throughout execution of the contract. The logic to coordinate can be contract term negotiating logic and/or auction logic and the binding contract can be a loan contract, with the loans being obtained through an auction process directly between lender and borrower. A lender might have a standing order that can be filled with loans to multiple borrowers, to provide diversification. Contracts and loans can be represented by sponsors, wherein a sponsor might introduce a borrower to the system as well as be part of the process of default management for the borrowers that sponsor brings to the table. Reputations might be tracked and used in contract term negotiating, including reputations of borrowers and reputation of sponsors who sponsor borrowers. Reputation values of sponsors might relate to performance of loans of borrowers sponsored by those sponsors. Risk mitigation might occur by way of personal relationships between borrowers and sponsors.

### CROSS-REFERENCE TO RELATED APPLICATIONS

This application is a divisional application of nonprovisional patent application Ser. No. 11/270,881 filed on Nov. 8, 2005 which claims priority from co-pending U.S. Provisional Patent Application No. 60/625,181 filed Nov. 8, 2004 entitled “Method and System for Lending Money Via a Communication Network.” in the name of Larsen et al. (hereinafter “Larsen I”); co-pending U.S. Provisional Patent Application No. 60/625,180 filed Nov. 8, 2004 entitled “Method and System for Credit Agreements” in the name of Larsen et al. (hereinafter “Larsen II”); and co-pending U.S. Provisional Patent Application No. 60/625,219 filed Nov. 8, 2004 entitled “Method and System for Debt Servicing (or) Sponsor Lending Platform” in the name of Larsen et al. (hereinafter “Larsen III”), each of which are hereby incorporated by reference, as if set forth in full in this document, for all purposes.

### FIELD OF THE INVENTION

The present invention relates to computer systems usable to coordinate lending processes in general and in particular to computer systems adapted to facilitate lending transactions to provide diversity and party anonymity without securitization.

### BACKGROUND OF THE INVENTION

Computer systems exist for coordinating lending processes, but they typically are configured to handle lending processes apart from binding contracts, i.e., by facilitating the process of coming to terms, outside of the computer system and by facilitating the printing and recording of binding contracts for a lending institution, etc.

Lending money involves capital management and risk assessment. Risk varies based on a number of conditions.

Where small loans are made between parties personally known to each other, a certain dynamic is involved, with advantages and disadvantages. One advantage of personal lending is that the borrower often feels a personal obligation to repay the lender, in addition to the contractual obligation. This lowers risk of default. A disadvantage is that large lending operations are cumbersome or impossible for personal connections.

Where a large loan volume is being handled, personal connections might not be available for each or even most of the loans being made, so the lenders have to use other risk assessment and mitigation techniques. In some cases, the risk is balanced by charging higher interest rates. A disadvantage, for borrowers, is the higher interest rates.

What is needed is a computer system for coordinating lending processes that overcome some of the shortcomings of the prior art.

### BRIEF SUMMARY OF THE INVENTION

In embodiments of computerized lending systems according to the present invention, terms of contracts are coordinated between a plurality of parties, each of which operate party client systems to interface to the electronic transaction processing system, including a database of transactions representing contracts, parties to the contracts and at least essential terms of the contracts. A typical system comprises logic for accepting party identification information of a first party from a first party client system and party identification information of a second party from a second party client system, logic to coordinate identification of at least the essential terms of a contract to be made between the first party and the second party, logic for detecting assent of each party, via their respective party client systems, to at least the essential terms of the contract, signaling to each of the first party and the second party the existence of a binding contract between the first party and the second party without identifying each party to the other, logic for coordinating execution of executable terms of the binding contract without identifying each party to the other, and the like.

In some embodiments, the logic to coordinate is contract term negotiating logic and/or auction logic. In some embodiments, the binding contract is a loan contract, the first party is a lender and the second party is a borrower and wherein the electronic transaction processing system includes logic to provide assurances to the first party of the creditworthiness of the second party without identifying the second party to the first party during contract formation or contract execution.

In some embodiments, reputations are tracked and used in contract term negotiating, including reputations of borrowers and reputation of sponsors who sponsor borrowers. Reputation values of sponsors might relate to performance of loans of borrowers sponsored by those sponsors. Risk mitigation might occur by way of personal relationships between borrowers and sponsors.

The following detailed description together with the accompanying drawings will provide a better understanding of the nature and advantages of the present invention.

### BRIEF DESCRIPTION OF THE DRAWINGS

FIG. 1 is a block diagram illustrating a lending and transaction processing system according to embodiments of the present invention.

FIG. 2 is a block diagram illustrating one of the client systems of FIG. 1 in greater detail.

FIG. 3 is a block diagram of components of an example client system.

FIG. 4 illustrates possible components of a program memory of a client system.

FIG. 5 illustrates possible components of data storage of a client system.

FIG. 6 illustrates example configurations of participant records in databases as might be stored in the data storage of FIG. 5.

FIG. 7 illustrates example configurations of records in logs as might be stored by the transaction server of FIG. 1.

FIG. 8 illustrates example configurations of transaction, bid and offer records as might be stored by the transaction server of FIG. 1.

FIG. 9 is a flowchart of an example process for using a computer system to match lenders and borrowers and to coordinate execution of agreements without parties needing to know identities of other parties.

### DETAILED DESCRIPTION OF THE INVENTION

An improved transaction handling system is described herein. While most of the examples shown herein relate to a computer system for facilitating borrowing, lending and repayment, other transactions might be facilitated by such a computer system. Other transactions might be transactions relating to marketplace analysis, static pool reporting, dunning, delinquency management, credit scoring, fraud detection, identity theft detection and the like.

In a lending transaction, a prospective borrower has terms that the borrower is willing to accept and a prospective lender has terms that the lender is willing to accept. If borrowers and lenders can be matched, the transaction handling system can generate a transaction and facilitate the transfer of funds from the lender to the borrower and repayment from the borrower to the lender in such a way that the contractors do not need to know the identity of the other party, even after and during repayment, until the contract is satisfied.

The specific embodiments described herein are examples of apparatus and methods according to the present invention. These embodiments can be used for facilitating transactions, supporting exchanges for connecting parties for transactions, and managing data in a novel manner. The operations are performed with the aid of a digital computing device or system, such as a computer, a computer program that can execute on a computer, a computer system comprising multiple processors, or a suitably configured interface and/or computing device.

### System Overview

The electronic transaction system described herein, and/or described or undescribed variations, facilitates lending money, auctioning of credit, diversifying credit, and the like, via a communication network. In embodiments, a potential lender offers to make loans using their client system and a potential buyer requests to receive loans using their client system, while the client systems communication with the electronic transaction system to coordinate offers and requests. The system uses a “diversification approach” to match offers to make loans and requests to receive loans. Customers offering to make loans can specify a level of diversification. The system combines the feature of matching offers and requests from individual customers with the feature of matching a customer's diversification request among many unrelated customers. The system provides a threshold approach to offers to make loans from a single customer and requests to receive loans from more than one customer.

A user interface is provided to convey auction information to potential lenders and potential borrowers. Note that this allows risk diversification requirements of potential lenders to be satisfied. The system notifies customers of successfully matched offers and requests and cumulative terms of the collection of offers and requests. The system can also be used to effect the financial transactions involved in loan repayment, such as collecting funds once from each repaying borrower (regardless of the number of lenders that contributed to that borrower's loan) and disbursing funds once to each lender in repayment (regardless of the number of borrowers that received loan proceeds from that lender).

A system and related methods can be used by potential lenders and borrowers to lend and borrow anonymously with anonymity maintainable throughout the lending process, including repayment. In a typical agreement, the borrower's identity might be disclosed if a loan is in default and the loan is referred to a collections agency. This is referred to herein as a method and system for “Double Blind Credit Agreements”.

Using a computer implemented approach to consumer credit agreements, debtors and creditors use personally identifiable information (PII) to offer and request credit without mandatory disclosure of PII to each other. The process of making credit agreements among the parties is separate from the disclosure of PII among the parties. The system has “conditional disclosures”, where PII of a debtor is disclosed to a creditor if the debtor defaults on the agreement terms, possibly after an “early warning” that warns defaulting debtors for a specified period of time before PII is disclosed. In order to distinguish among relative credit risks, potential lenders can be provided with credit scores associated with the loans they make, or the lenders can include acceptable credit scores or ranges as conditions of the loans they make (e.g., “I will loan $1000 to borrowers with a credit score of at least a “B” rating, with a minimum interest rate of 10% and no more than $250 to any one borrower; each of the borrowers must also be a member of a sponsored group with at least a four star rating for the group.”). Notably, by matching “standing orders”, such as that example, with potential borrowers' loan requests, the lender can achieve loan diversification while still having defined loans with specified (albeit possibly anonymous) borrowers.

Using the above-described system or a separate computer system, loans can be serviced and a process implemented for enforcing terms of customer agreements. Where borrowers are held out as members of a sponsored group, a sponsor is held responsible for the creditworthiness of the member borrowers. Borrowers are associated with one or multiple sponsors. A sponsor is responsible for referring borrowers and for monitoring borrower performance over a specified time and consequences of borrowers' actions are imposed on sponsors. For example, a borrower's successful repayment of credit might trigger a proportional benefit to that borrower's sponsor(s), such as increase rating and possibly compensation, which the sponsor may share with the group or not. A debtor's default might trigger a proportional penalty to that borrower's sponsor(s).

In this manner, social networking can be used to bring borrowers together and group pressures and personal relationships can be used to ensure repayment. Sponsors might earn acquisition rewards based on the creditworthiness of the borrowers they bring in. Sponsors might earn a portion of the rates paid to lenders as loans are repaid. Sponsors might be rewarded even with some defaults, if the default rate for that sponsor is less than an expected default rate that was taken into account when the loans were made to that sponsor's group's members.

Furthermore, sponsors without funds but having clout within a group can perform a banking function (at least an unofficial “banking”-like function) for members of the group, by sponsoring those members for loans and other contracts. A sponsor can bring in borrowers and contract parties, as well as performing a passive default avoidance role such that a sponsor's reputation is used to help the group's members obtain loans and contracts and a member might be influenced to perform promised actions under their contracts knowing that their sponsor's reputation (and possibly also the sponsor's compensation) would be diminished if the member fails to perform promised actions, such as making timely repayments on a loan contract. For example, a sponsor might introduce a borrower having a personal connection to the sponsor and lenders might lend to that borrower on the strength of the sponsor's reputation. When a potential default situation arises, the sponsor can be notified and the borrower informed that the sponsor will be notified, thereby using the sponsor's personal relationship with the borrower to influence the borrower to cure the default or potential default, wherein the borrower might be influenced by knowing that the sponsor, with whom the borrower has a personal relationship, will have a reduced reputation and will stop receiving repayment-based compensation if the borrower does default.

### Description of Figures

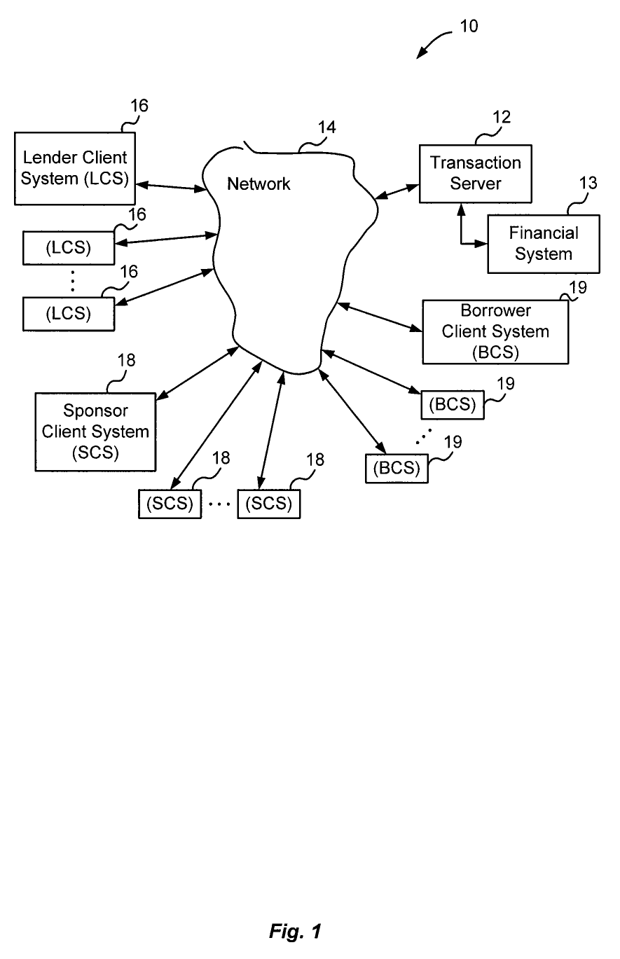

As shown in FIG. 1, a lending and transaction processing system 10 according to embodiments of the present invention might comprise a transaction server 12 coupled to a network 14 which provides for interaction between various client systems and transaction server 12. Transaction server 12 is also shown coupled to a financial system 13 for effecting funds transfers and the like. The client systems include lender client systems 16, sponsor client systems 18 and borrower client systems 19, each of which has operations described in more detail below. Using lending and transaction processing system 10, lenders can make offers for loans, borrowers can make bids and lenders and borrowers can arrange for loan transactions. Such transactions can have a variety of terms, such as interest rate, payment periods, loan amount, etc. Transaction server might handle the transaction anonymously by making withdrawals from a bank account of the borrower according to the terms of the transaction and making deposits to the bank account of the lender according to the terms of the transaction, as well as the initial transfers that started the loan.

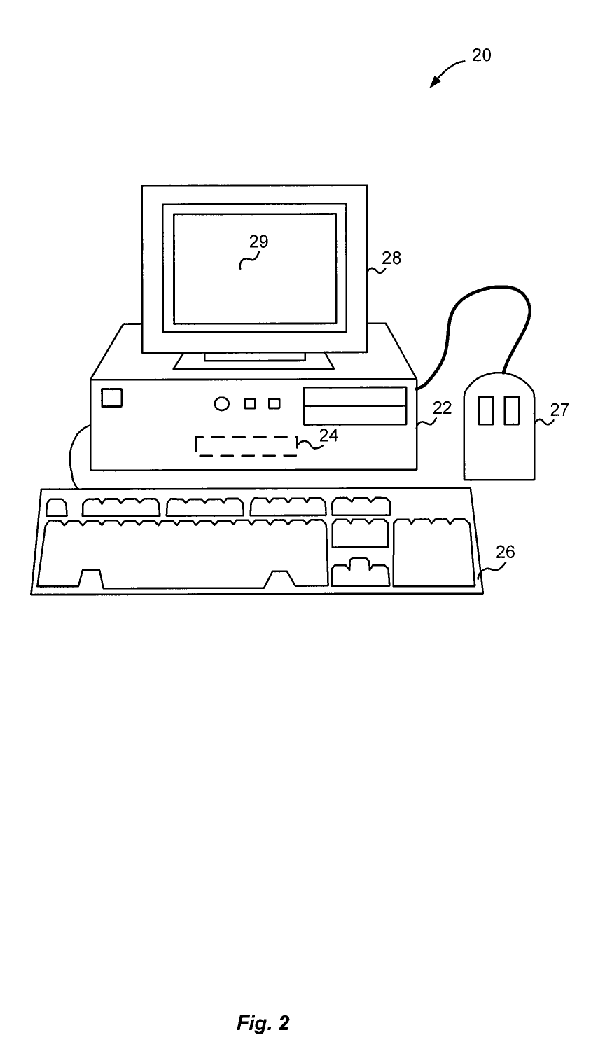

FIG. 2 is a block diagram illustrating one of the client systems of FIG. 1 in greater detail. As shown there, a client system 20 comprises a computer 22 having an internal hard disk 24 and being coupled to a keyboard 26 and a mouse 27 for accepting user input and to a monitor 28 for presenting output on display 29. Any suitably configured personal computer or other computing or networked or standalone appliance or device could be used as client 20, so long as it accepts user input and provides a responsive display of data selected using the user input.

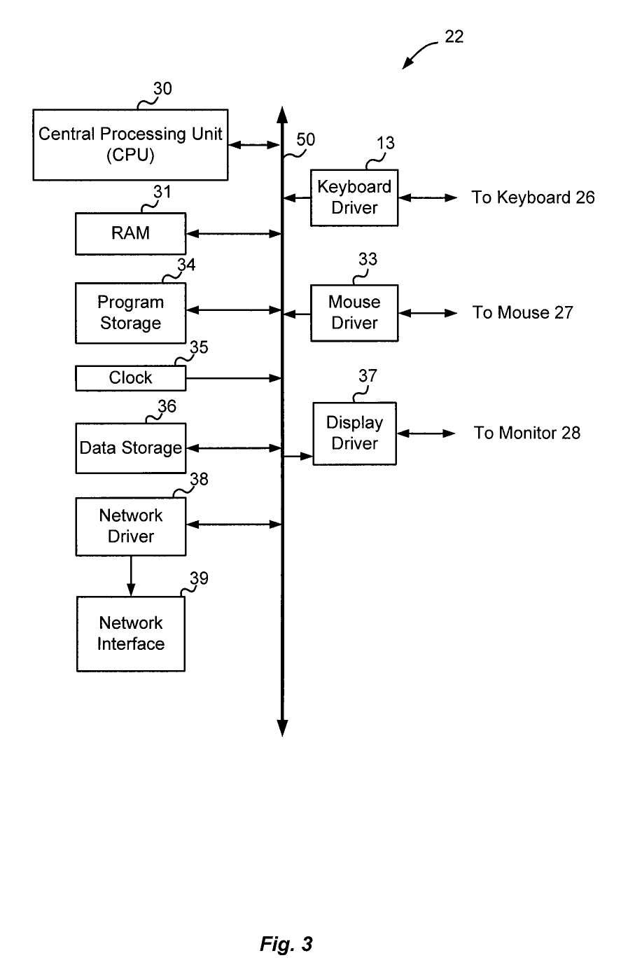

FIG. 3 shows one suitable internal configuration of computer 22, which can be any standard personal computer with enough computing power to display information and having network connectivity. Computer 22 is shown including a central processing unit (CPU) 30, random access memory (RAM) 31, program storage 34, a clock 35, data storage 36 and various drivers for peripherals, such as keyboard driver 32, mouse driver 33, and display driver 37. Each of the drivers and other devices are coupled to CPU 30 to send and receive instructions, commands and/or data, using a bus 50. As is well known in the art, program storage 34 might be in the form of read-only memory (ROM) or program code loaded from hard disk 24. Program storage 34 might also be implemented in portions of RAM 31. Data storage 36 might also be implemented in portions of RAM 31, ROM or hard disk 24.

For network connectivity, a network driver 38 couples a network interface 39 to bus 50. Each of the drivers 38, 32, 33, 37 and 39 might be implemented in hardware, software or both. Network interface 39 allows computer 22 to send and receive data from a network connected to network interface 39. Many types of network interfaces are known. For example, network interface 39 might comprise an Ethernet™ card inserted into a motherboard of computer 22 and an Ethernet™ cable connected to the card. In another example, the interface might be implemented using a modem and a telephone line for either direct connection or dialup connection to a network.

The network 14 could be a local area network (LAN), a wide area network (WAN), or an internetwork of networks, such as the Internet, a global internetwork or networks supporting several different services and types of traffic, such as hypertext transport protocol (HTTP) traffic for viewing and navigating hypertext pages from various HTTP servers coupled to the Internet. The collection of such hypertext pages is often referred to as the “World Wide Web” (or “the Web” or “WWW”, for short). Intranet operations are also contemplated. Other protocols, such as XML, can be used as well or instead. Protocols might be used for computer-to-computer data transport.

It should be understood that there are many known methods and apparatus to connect a personal computer or any other computing or networked or standalone appliance or device as a client to the Internet or other network and any of those methods and apparatus can be used in place of the specific configurations shown in the figures. For example, the client can be a personal computer, set-top box device, cellular telephone, portable telephone or personal digital assistant (PDA), or the like. Devices might have keyboards, no keys, memory storage or no local storage, and perhaps a voice interface.

It should also be understood that many more clients and servers (and client/servers) can be coupled to the Internet than are shown in FIG. 1.

An example of display 29 might be a browser. The user might interact with the various components of a browser display by moving a cursor to selected components. Alternatively, other user interface techniques could be used. Using the browser, the user can navigate, browse, retrieve, display, review, enter, edit, validate and/or verify data, where the data can be characters, text, images, graphics and/or other representations of information having meaning to a human or a computing device interacting with the browser.

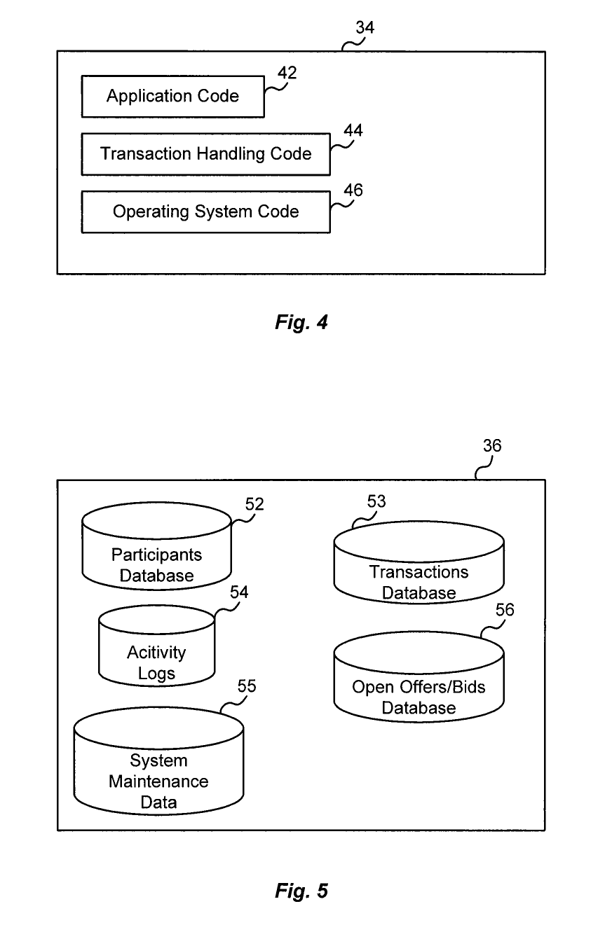

FIG. 4 illustrates possible components of a program memory of a client system. As shown there, program storage 34 includes application code 42, transaction handling code 44 and operating system code 46.

FIG. 5 illustrates possible components of data storage 36 of a client system. As shown there, data storage is provided for a participant's database 52, a transactions database 53, activity logs 54, a system maintenance data store 55, and an open offers/bids database 56.

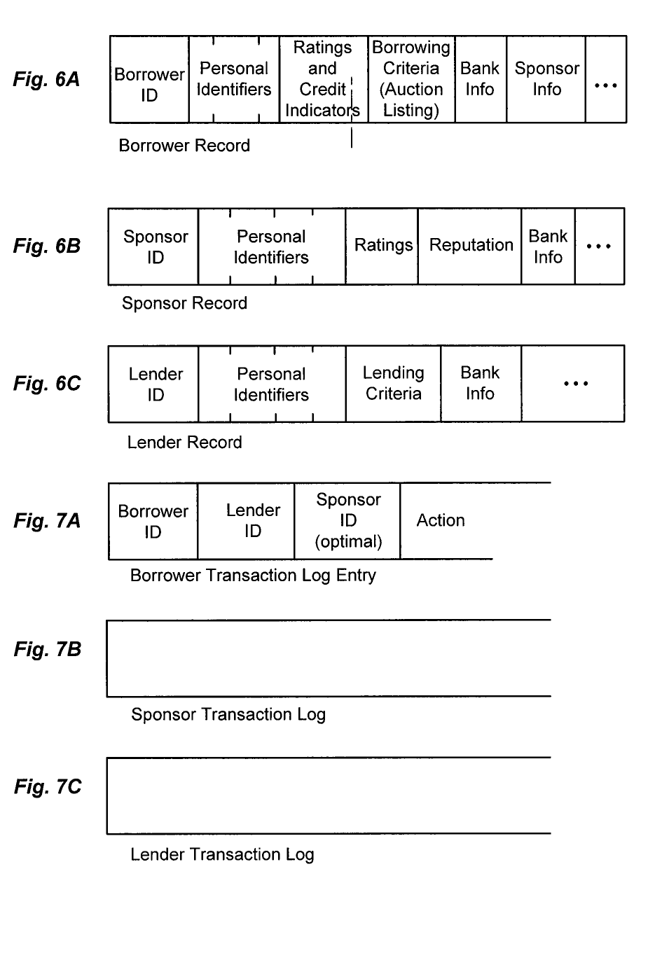

FIG. 6 illustrates example configurations of participant records in databases as might be stored in the data storage of FIG. 5. For example, FIG. 6A illustrates a borrower record comprising a borrower ID, personal identifiers, ratings, credit indicators, bank information, a sponsor ID, borrowing criteria and possibly other fields. By using a system-assigned borrower ID, a borrower can participate in transactions without being personally identifiable. Personal identifiers would allow the system operator to identify the borrower, contact the borrower by e-mail, phone, etc. Ratings allow the system to signal to other participants the rating of the borrower associated with the record. Bank information for the borrower is used by the system to electronically effect funds transfers, such as a transfer from a lender to the borrower (at the start of a loan) and a transfer from a borrower to the lender (as payments are due). Alternatively, the transfers to and from the borrower could be to a system operator account, such as a clearing account or a trust account. The sponsor ID (where used) links the borrower to a sponsor, which might be used as a condition of making a loan, as described below. Borrowing criteria might include a maximum acceptable interest rate, loan amount, etc.

FIG. 6B illustrates a sponsor record comprising a sponsor ID, personal identifiers, ratings, sponsor reputation data, bank information, and possibly other fields. A sponsor has sponsor ratings and can obtain benefits if borrowers sponsored by that sponsor perform well in making transactions.

FIG. 6C illustrates a lender record comprising a lender ID, personal identifiers, lending criteria, bank information, and possibly other fields.

FIG. 7 illustrates example configurations of records in logs as might be stored by the transaction server of FIG. 1.

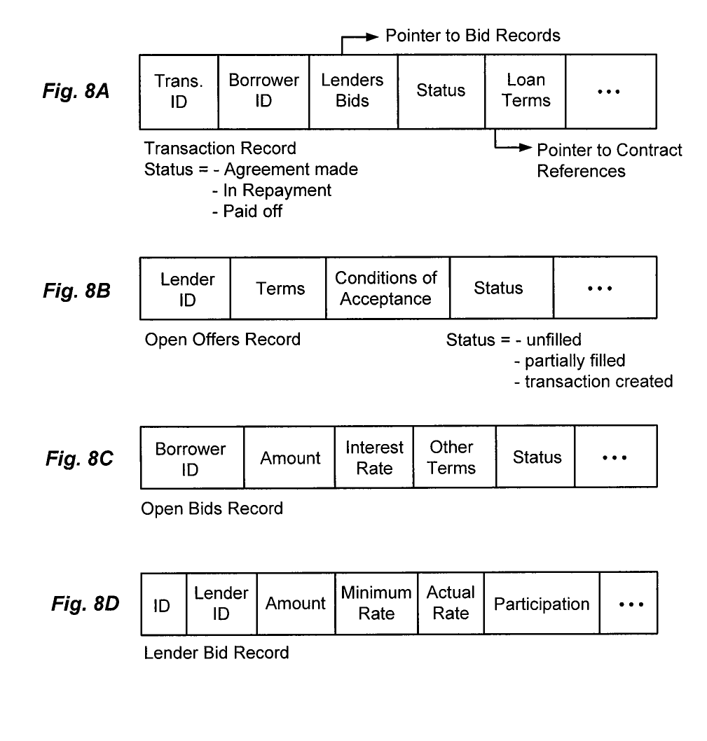

FIG. 8 illustrates example configurations of transaction, bid and offer records as might be stored by the transaction server of FIG. 1.

As shown in FIG. 8A, a transaction record might include a transaction ID, a borrower ID, zero, one or more pointers to lender bids, a status field, requested loan terms (possibly including pointers to contract references). Status might include indications of whether an agreement is made, a repayment process started, the loan was paid off, etc. Where a given transaction represents a loan to a borrower from multiple lenders, more than one lender pointer would be present.

FIG. 8B illustrates an example of an open offers record. As shown there, a record includes a lender ID, terms, conditions of acceptance, status and possibly other fields. An open offer is an offer to lend money that has not matured into a transaction.

FIG. 8C illustrates an example of an open bid record. An open bid is a bid for a loan from a borrower, indicating terms the borrower will accept. As shown, an open bid record includes a borrower ID, an amount, an interest rate, possibly other terms, status and possibly other fields.

FIG. 8D illustrates an example of a lender bid record. A lender bid record represents a lender's portion of a consummated transaction. As shown, a lender bid record includes a lender ID, an amount, a minimum interest rate, an actual rate, possibly other terms, status, participation and possibly other fields.

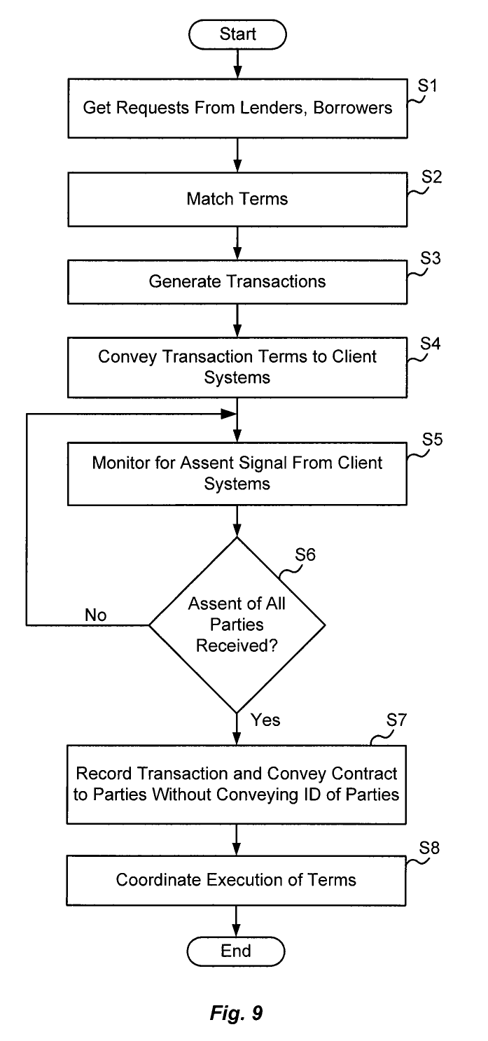

FIG. 9 is a flowchart of an example process for using a computer system to match lenders and borrowers and to coordinate execution of agreements without parties needing to know identities of other parties. The steps are labeled for explanation purposes, but the order of the steps is not necessarily in order of the labels.

In step S1, the transaction system obtained requests from lenders and borrowers. A borrower request might include a request for a loan under certain terms (payment period, loan amount, interest rate, up-front fee, prepayment penalty, points, etc.). A lender request might include a request to loan money under certain conditions (such as loaning a set amount at a minimum interest rate to a diversified group of borrowers). In step S2, the system matches terms between borrowers and lenders. This might be done by processing contents of database 56. Once matches are found, the system generates transactions (S3) and transmits details of the transactions to client system associated with the transacting identifiers (S4). The method of contacting parties to the transaction might be stored in their respective records in the participants database. In some embodiments, the details do not include personal identifiers, but in some embodiments, the parties might be able to identify each other.

In step S5, the system monitors for assent of the parties. This might occur by the parties using their respective client system to send an e-mail or a web page response back to the system. In some cases, assent might be automatic, such as where one party agrees in advance to a transaction meeting prespecified criteria. If, at step S6, all parties signal assent, the transaction is recorded (S7) and the system coordinates execution of terms (S8) as needed.

Examples of coordinating execution of terms might include sending reminders of upcoming transaction events, transferring funds, etc.

Using the system described above, individuals and other entities can offer loans over a network of borrowers, with automatic diversification as needed, and individuals and other entities can offer to take on loans, thus forming an electronic exchange connecting those who wish to borrow money (“borrowers”) with those who have money to lend (“lenders”).

Prospective borrowers would be graded and ranked by a combination of their credit score, their debt-to-income ratio and possibly other factors. Borrowers' credit grades and ranks would be made available to prospective lenders on an anonymous basis. Prospective borrowers would “bid” for an unsecured loan by indicating the maximum interest rate the borrower is willing to pay and other essential terms.

To participate in the marketplace, prospective borrowers might join a small borrowing group or community and gain access to the marketplace through the group's leader or “sponsor.” Groups could be characterized by nationality, neighborhood, profession, religion, school, lifestyle, common interests or other affiliation, similar to the diverse types of peer-to-peer groups that populate online communities. Group sponsors would receive compensation for bringing individuals to the marketplace (which could be shared among members at the sponsor's discretion), and for promoting good payment performance by members of their group. Sponsors would be notified of payment defaults of members of their group, and groups would be ranked by their historical payment performance. Although borrowers would borrow money individually, their association with a small sponsor-led credit group or community should motivate good payment performance, as a borrower would be less likely to default if default would negatively affect the community and sponsor. Naturally, higher rated groups would attract more numerous and more favorable lender bids relative to lower rated groups.

The individual lenders would access the marketplace and indicate the amount they are willing to lend, the minimum interest rate they are willing to accept, the credit and community group characteristics of the borrowers they are willing to finance and possibly other terms. Term periods might be 12 months, three years, or other term.

If a match is made, the borrower would receive an unsecured fully amortizing loan, for example. A fee, or a portion of the loan proceeds, might be allocated to the system operator at the time of loan funding. Borrowers could prepay their loans at any time without penalty, and lenders could sell a loan at any time to another lender by re-bidding using the system, for a transaction fee. The system would facilitate loan funding, servicing and collection, and the system operator would receive bid listing fees and servicing fees.

The transaction system can serve as an electronic auction platform, in addition to handling transaction and participant details, such as matching and settlement of bids, servicing and collection of loans, and group membership.

In a sponsored embodiment, borrowers must be invited by a sponsor, or must find a sponsor, in order to register their client system with the transaction server and thus participate in the marketplace. Sponsors, as the individual leaders of the various credit groups, draw borrowers to the marketplace. Sponsors will know the identity and the grade and rank of their group members, and will be notified of any defaults by borrowers in their credit group. Sponsors will receive compensation for bringing borrowers to the marketplace, and they will receive additional compensation for better-than-expected payment performance on the par of their group's borrowers.

The lenders are individuals or entities that provide the loan funds to be disbursed to the borrowers. To comply with regulatory requirements, the system operator might be designated as the lender for regulatory purposes and will resell a promissory note of a transaction to the designated lender providing the funds.

The transaction system might also interface to debt buying systems to automatically transfer details of loans in default for collection purposes. The transaction system might also have logic for handling an auction for loans similar to the process for bidding for loans.

### Obtaining a Loan

During a registration process, an individual's identity is authenticated and the individual is provided with terms and conditions specific to their respective role.

Borrowers who pass authentication are assigned a credit “grade”. An example set of grades might be (AA, A, B, C, D, E and HR) from AA (highest grade) to HR (lowest grade; high risk) based on their credit score. Borrowers might also be assigned a credit “rank” based on their non-housing-related debt-to-income ratio (or some other test) as reflected on their credit report or other source of information. Borrowers might be ranked into bands (such as 5, 9 or 15) non-housing debt-to-income bands. For example, in a nine band embodiment, the highest band (band 1) might relate to a 10% ratio, while a 9 might relate to an “over 50%” ratio.

Borrowers who are not already members of an approved group request sponsorship, i.e., membership in an approved group,—in order to be eligible to place a bid in the marketplace.

Sponsor registration involves a request for approval of the sponsor's group. Groups could be of virtually any type; they could be characterized by nationality, family, profession, religion, school, lifestyle or other affiliation, or by common interests such as travel, music, sports or entertainment. Of course, the system operator would not enforce any particular borrower characteristic for membership of a group. Other than accepting a borrower into the group, the sponsor preferably has no further role in the registration or bidding process.

Lenders who register and pass authentication are eligible to bid for credit.

Participants provide deposit account information to facilitate electronic funds transfers, such as Automated Clearing House (ACH) transfers of funds or credit card details for loan payments and/or charges in the event of a payment default.

### Bidding for Credit

Once registered, borrowers and lenders may bid using their client systems to interact with the transaction server for loans according to system rules. For example, the system might limit lender offers to loans in amounts ranging from $2,500 to $25,000. Using their respective client systems, borrowers indicate the maximum interest rate they are willing to pay, and lenders indicate the minimum interest rate they are willing to receive. Borrowers' requests for loans, e.g., borrowers' bids—are presented by the system for auction, such as by creating and formatting web pages for display on lender client system browser pages. The bids might be listed by credit grade and rank, borrower location and group ranking and/or other characteristics. Groups are ranked by their collective payment performance, and group rankings might also be displayed. Lenders can use their browsers to peruse available borrower bids for bids that meet the lender's designated criteria, or they can commit funds to be matched with borrower bids that meet specified criteria. Borrower and lender bids are submitted electronically.

Borrower Bidding. To post a bid, borrowers enter the amount of the loan they are seeking, the minimum loan amount they would accept, the maximum interest rate they are willing to pay, the duration of their bid and other essential terms. Borrower bids might have short expirations so that lenders can rely on credit reports taken at or near the date of the bid being made. In some embodiments, borrowers are limited in the number of loans they can obtain, but might be allowed more bids than that number. Borrowers' credit grades and ranks are posted with their bid.

Lender Bidding. Lenders can bid selectively, by browsing through and accepting one or more borrower bids that appeal to the lender (“selective bid”). Lenders can also make an “open” bid by indicating the amount the lender is willing to lend, and the interest rate and borrower and group criteria the lender would accept if available, along with any other essential terms. Lenders can employ either or both types of bids. Lender minimums might be enforced.

Selective Lender Bids. To bid selectively, lenders use their browsers to search borrower bids and browse through available bids by credit grade and rank, borrower location, and group rankings and other characteristics. Credit groups might be ranked according to their collective default performance relative to the market for similar credit, and group rankings displayed, along with the grade, rank and individual default performance of each member of the group. Lenders also see desired loan amount, offered interest rate, borrower credit grade and rank, borrower location, and group ranking and other characteristics.

Open Lender Bids. To make an open bid, the lender might convey to the transaction system the amount of funds available to lend, the maximum loan amount that may be advanced to one borrower, the minimum interest rate the lender is willing to receive, and the desired borrower credit grade and rank, borrower location, and group ranking and other characteristics. When a lender makes an open bid, the transaction system automatically match bids on any then-outstanding, or future borrower bids meeting the criteria selected, that offer an interest rate higher than the bidding lender's minimum acceptable rate. Borrower bids with the highest offered rates above the lender's minimum will be matched first, and thereafter the lender's bid will be matched to borrower bids with incrementally lower offered rates (but still at or above the lender's minimum acceptable rate) until all of the lender's funds are placed. Other known auction techniques might be used as well or instead.

The lender can accept as many borrower bids as the lender desires, until all of the lender's funds are placed. Whether a lender makes an open bid or bids selectively, the transaction system enables lenders to diversify repayment risk by allowing bidding lenders to direct that their loan be divided among more than one borrower. Upon submission of a bid, a lender may designate that their bid be matched with up to 50 matching borrower bids, for example. Depending on the number and type of borrower and lender bids posted, a borrower's bid may be matched with more than one lender bid.

At the time bids are made, the bidding lender or borrower electronically signs an agreement committing the bidder to the terms of a loan, should the bid be matched. Borrowers' bids and lenders' open bids remain for the duration of the bid, as specified by the borrower or lender. Bids remain open until they are matched, expire or are withdrawn by the borrower or lender who posted the bid.

### Lender to Lender Re-Bidding

To provide liquidity for lenders, lenders can use the transaction server to sell a loan to another registered lender by “re-bidding” the loan using the transaction server.

### Settlement of Bids

When a lender's bid is matched with a borrower's bid meeting the lender's designated criteria, the bids are settled. A matched pair of bids results in a loan between the system operator and the borrower and is then contemporaneously sold and assigned to the lender or lenders whose bid or bids are matched with the borrower's bid. In other embodiments, direct lending occurs.

Each loan can be evidenced by one or more promissory notes. In one embodiment, the loans have identical payment terms, just different interest rates and amounts, with all loans being closed-end, unsecured fully amortizing loans with a fixed term. Because of the automated matching, one borrower's loan might be split over multiple lenders and one lender's loan might be split over multiple borrowers.

The notes might allow prepayment by the borrower at any time without penalty. In such an embodiment, the only loan-to-loan variations are the auction-driven interest rate and the loan amount. If at the time of bidding the lender directs that the bid be matched with more than one borrower bid, the transaction system will trigger as many promissory notes as necessary to achieve the lender's requested risk-diversity.

The transaction system can use a “double blind credit” feature with its loans, wherein neither the borrower nor lender knows the other's identity, even through completion of the loan and repayment. When bids are matched, the resulting promissory notes might list randomly generated reference numbers (e.g., borrower ID, lender ID) in place of the names of borrowers and lenders, and the notes are signed electronically.

Upon settlement, the borrower's sponsor is informed of all loans to borrowers within the sponsor's group, and in the event a borrower defaults on a loan and the default is not cured within sufficient time, the borrower's sponsor is notified of the default. The identity of the borrower and sponsor is never disclosed to the lender, and the identity of the lender is never disclosed to the borrower or the sponsor. Although the sponsor's identity might not be disclosed to the lender, a lender might know the borrower's group.

Settlement occurs instantly when bids are matched, as lenders must keep funds in at least the amount of the lender's bid in the trust account as a condition of posting and maintaining a bid. Loan proceeds are transferred from the lender's trust account into the borrower's designated account. If a lender designated that its bid is to be matched with more than one borrower for risk diversification purposes, the lender's funds would be disbursed from the lender's trust account into each borrower's account. Similarly, if more than one lender's bid is matched with a borrower's bid, the borrower would receive a single payment from the trust account, rather than individual payments from each lender.

The transaction system maintains electronic records of loan disbursements and borrowers' payments.

If a borrower fails to make a loan payment when due, the transaction system will notify the borrower via e-mails or the like, with escalating levels of urgency, of the payment requirement, and make additional attempts to complete a funds transfer into the trust account. If the delinquency is not cured, the transaction server notifies the borrower's group sponsor of the delinquency, so that the sponsor could facilitate cure of the delinquency.

### Loan Sales of Written-Off Loans

The transaction system might also facilitate loan sales, such as where a loan is written off and sold to an unaffiliated third-party debt buyer. Licensed debt buyers might register with the transaction system and bid for and purchase written-off loans through in an auction environment. Prospective debt buyers would be able to view details of the loan, except for the identity of the borrower and lender. The debt buyer offering the highest price for a written-off loan would purchase the loan, and the lender would have no further interest in the loan. Proceeds of a loan sale to a debt buyer would be paid to the lender.

### Platform Compensation

The transaction system operator might charge fees for loans, bids and notifications. For example, the system operator might charge for automatic credit monitoring that would enable borrowers or lenders on a loan to monitor the borrower's credit grade and rank for the duration of the loan.

Sponsors receive compensation for bringing borrowers and for good payment performance by the sponsor's borrowers. In one embodiment, the sponsor's compensation has two components: an acquisition component comprising a flat fee paid by the system operator and a monthly performance component paid by the lender from loan payments received. Borrowers' association with a small sponsor-led credit group or community is designed to motivate good payment performance, so sponsors receive rewards for good payment performance by paying them a predetermined amount, based on the borrower's credit grade, for each timely payment made by a sponsored borrower.

Each credit grade is assigned a designated default percentage (e.g., “D” Credit grade=3%), based on aggregate payment performance, default statistics for similar credit or other criteria. The default percentages would be higher for borrowers with low credit grades, because loans to borrowers with low grades are expected to experience a higher percentage of defaults. Sponsor payments might be based on a monthly performance “premium” based on whether performance was better or worse than the expected percentage of default.

### Automatic Diversification

As explained above, a lender can lend money in what might be treated as a single transaction but lends to a plurality of borrowers. In addition, a given borrower might borrow from a plurality of lenders in what appears to be a single transaction. The transaction system might simplify the executory process (i.e., the loan repayment over time) by collecting one payment per borrower, depositing borrower payments into a trust account, and then disbursing one return of capital and interest payment to each lender. With suitable controls, the transaction system can track the borrower-lender-amount values for each divided fractional interest in the trust account funds.

Borrowers bid to make loans, indicating the desired amount, desired interest rate, and possibly other terms. Lenders bid to buy loans indicating an amount, desired interest rate and credit spectrum (e.g., a range of acceptable credit scores of borrowers). The transaction system does not determine whether a particular borrower gets a loan or whether a particular lender gets to buy a loan, except possibly through a random assignment where there are more equally-rated borrowers than lenders, or vise versa. Instead, whether a borrower gets a loan depends on the borrower's credit rating and maximum interest rate. If there are sufficient lender bids to cover the loan, the borrower gets the loan and the lender(s) to which the loan is assigned take on the risk of default. On the other side, the lender gets to buy loans when there are sufficient buyers within the lender's credit spectrum that are willing to accept at least the minimum interest rate set by the lender.

Thus, by bidding to buy loans, a lender obtains diversification automatically when the loan assigned to a winning lender comprises multiple loans or portions of loans from multiple borrowers. Since the lender's interest is not a pooled, undivided interest in a fund, the lender's interest is diversified and the lender has control over performance of the investment, subject to transaction fees, individual borrower defaults and/or prepayments.

For defaulted loans, the lender can sell the loan to a collection agency. The transaction system can facilitate that process, but it is not required for agency selection or collection.

Although an auction might generate multiple transactions among multiple lenders and multiple borrowers, in a preferred embodiment, each transaction can be divided into one-to-one transactions between one borrower and one lender even where one or both parties are unaware of the particular division.

While the invention has been described with respect to exemplary embodiments, one skilled in the art will recognize that numerous modifications are possible. For example, the processes described herein may be implemented using hardware components, software components, and/or any combination thereof. Thus, although the invention has been described with respect to exemplary embodiments, it will be appreciated that the invention is intended to cover all modifications and equivalents within the scope of the following claims.

1. An electronic transaction processing system for matching contracting parties for contract formation, comprising at least a first party that agrees under a contract to perform a first action and a second party that agrees under the contract to perform a second action following the performance of the first action of the first party, wherein the first party and the second party operate party client systems to interface to the electronic transaction processing system, the electronic transaction processing system including a database of transactions representing contracts, parties to the contracts and at least essential terms of the contracts, the system comprising:
logic for accepting party identification information of a first party from a first party client system and party identification information of a second party from a second party client system;
logic for determining a sponsor identifier for the second party, wherein the sponsor identifier of a contract indicates a sponsor that is associated with the second party and the contract;
logic for gathering and asserting a reliability metric of the second party to perform the contracted for action of the second party following the contracted for action of the first party, wherein the reliability metric assigned is a function of a stored sponsor reputation value;
logic for determining essential terms of a transaction from prospective first parties;
logic for determining essential terms of a transaction from prospective second parties;
logic for coordinating agreements between first parties and second parties using an auction process;
logic for coordinating execution of executable terms of the binding contract; and
logic for sending messages to sponsor client systems such that when a contract is flagged as a potential default, a potential default being a contract wherein the first party to the contract has performed the first action but the second party to the contract is out of compliance with the second action, the sponsor associated with the contract is notified via a potential default message.

2. The electronic transaction processing system of claim 1, wherein the first party is a lender, the second party is a borrower, the contract is a loan agreement, the first action is the lending of money as specified in the loan agreement and the second action is the repayment of the money as specified in the loan agreement.

3. The electronic transaction processing system of claim 2, wherein the reliability metric is further a function of a credit score of the second party.

4. The electronic transaction processing system of claim 2, wherein the logic for coordinating agreements between first parties and second parties using an auction process comprises logic for allocating a lender loan amount among a plurality of borrowers.

5. The electronic transaction processing system of claim 4, wherein the logic for allocating a lender loan amount among a plurality of borrowers operates according to an offered total loan amount and a lender-specified maximum loan-per-borrower amount such that the offered total loan amount is allocated in total over a plurality of borrowers without exceeding the lender-specified maximum loan-per-borrower amount for any of one of the plurality of borrowers.

6. The electronic transaction processing system of claim 1, wherein a plurality of second parties is a group of parties sponsored by a sponsor and that sponsor's sponsor identifier is associated with contracts entered into by members of the group, further comprising:
adjusting the sponsor reputation value of the sponsor according to performance of second actions by members of the group.

7. The electronic transaction processing system of claim 6, further comprising compensating the sponsor according to performance of second actions by members of the group.

8. The electronic transaction processing system of claim 1, further comprising receiving introduction messages at the electronic transaction processing system from sponsor client systems, wherein an introduction message indicates an identity of a second party and an indication that the sponsor operating the sponsor client system sponsors the second party for a contract.

9. The electronic transaction processing system of claim 1, wherein the logic for gathering and asserting creditworthiness of borrowers operates in dependence upon group associations, such that a borrower's asserted creditworthiness depends on a rating of a sponsor of a group in which the borrower is a member.

10. The electronic transaction processing system of claim 1, wherein the auction process includes standing orders with criteria specified by first parties, wherein a standing order is a loan offer and the contracts are loans, criteria includes a minimum interest rate the first party will accept.

11. The electronic transaction processing system of claim 1, further comprising a database of standing orders including storage for indications of bidders' maximum contract size per individual acceptor, and further comprising logic for pairing portions of a bidder's standing order with a plurality of acceptors when a bidder's standing order is larger than the bidder's maximum contract size, thereby providing the bidder with automatic diversity of pairings.

12. The electronic transaction processing system of claim 1, wherein the contracts are loans and wherein a standing order is an open obligation on the part of a bidder to fund one or more loans up to a standing order amount with at least one constraint, wherein the at least one constraint includes at least an acceptable credit score value or range, such that a bidder's standing order having a minimum credit score value is not matched with acceptors having credit scores below the minimum credit score value, and wherein a database of records of standing orders includes storage for, for each standing order, a loan commitment amount, a minimum credit score value and a minimum acceptable interest rate.

13. The electronic transaction processing system of claim 1, wherein the contracts are loans, the first party is a lender and the second party is a borrower, the electronic transaction processing system further comprising:
logic for transferring aggregated loan funds from a lender upon contract commitment, wherein a single transfer can cover a plurality of paired contracts with borrowers, wherein a lender is a winning bidder and a borrower is a winning acceptor;
logic for transferring aggregated loan proceeds to a borrower upon contract commitment, wherein a single transfer can cover a plurality of paired contracts with winning bidders;
logic for transferring aggregated loan repayment funds from the borrower in a repayment period of a paired contract wherein a single transfer from the borrower can cover a plurality of paired contracts with lenders; and
logic for transferring aggregated loan repayment funds from a plurality of borrowers to a lender in a repayment period of a paired contract wherein a single transfer to the lender can cover a plurality of paired contracts with a plurality of borrowers.

14. The electronic transaction processing system of claim 1, further comprising logic to generate an auction user interface, wherein potential lenders can post standing orders for loans with loan terms and potential borrowers can accept loans with offered loan terms.
